(19) United States
(12) Patent Application Publication
(10) Pub. No.: US 2007/0231607 A1
(43) Pub. Date: Oct. 4, 2007

(54) Substrate for magnetic recording medium, fabrication method thereof, and magnetic recording medium

(76) Inventors: Masaru Ito, Tokyo (JP); Ken Ohashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/723,228

(22) Filed: Mar. 19, 2007

(30) Foreign Application Priority Data
Mar. 31, 2006 (JP) 2006-097603

(51) Int. Cl. G11B 5/66; G11B 5/706; B05D 1/18

(52) U.S. Cl. 428/827; 428/829; 428/846.2; 428/846.3; 427/443.1

(57) ABSTRACT

A soft magnetic under layer (SUL) is formed on a non-magnetic substrate by an electroless plating method. The SUL formed by plating is subjected to magnetic field heat treatment on conditions that the heat treatment temperature is 150° C. to 350° C., a magnetic field applied to the substrate has a strength of 50 oersteds (Oe) or more, and the treatment time is selected within a range of five minutes to ten hours. Through the magnetic field heat treatment, magnetic anisotropy is obtained with a difference (δH=H_{d}−H_{c}) of 5 oersteds (Oe) or more in terms of absolute value between a magnetization saturation magnetic field strength (H_{d}) in the in-plane radial direction of a soft magnetic film and a magnetization saturation magnetic field strength (H_{c}) in the in-plane circumferential direction of the soft magnetic film, and the magnetic anisotropy is symmetric with respect to the axis of the substrate.

### BACKGROUND OF THE INVENTION

1. Field of the Invention

The present invention relates to a substrate for a magnetic recording medium, a fabrication method thereof, and a magnetic recording medium, and specifically relates to a substrate suitable for the fabrication of a perpendicular magnetic recording medium having excellent signal reproduction characteristics with low noise and a fabrication method thereof.

2. Description of the Related Art

In the technical field of information recording, hard disk drives acting as means for magnetically reading/writing information including characters, images, and music have become necessary as primary external recorders or internal recording means of electronic equipment such as personal computers. Such hard disk drives include hard disks serving as magnetic recording media. For conventional hard disks, so-called “in-plane magnetic recording method (longitudinal magnetic recording method)” has been used in which magnetic information is longitudinally written in the plane of a disk.

FIG. 1 is a sectional view schematically showing a typical multilayer structure of a hard disk of the longitudinal magnetic recording method. A non-magnetic Cr base layer 2 formed by sputtering, a magnetic recording layer 3, and a carbon layer 4 serving as a protective film are sequentially stacked on a non-magnetic substrate 1, and a liquid lubricating layer 5 is formed on a surface of the carbon layer 4 by applying a liquid lubricant thereon. These layers are not more than 20 nm in thickness. Generally, such films are all formed by a dry process including a magnetron sputtering method (for example, see patent document 1: Japanese Patent Laid-Open No. 5-143972). The magnetic recording layer 3 is made of a Co alloy of uniaxial crystal magnetic anisotropy. The Co alloy includes CoNiCr and CoCrPt alloys. The crystal grains of the Co alloy are horizontally magnetized on a surface of the disk, so that information is recorded.

However, in the perpendicular magnetic recording method, an increase in recording density has been regarded as being restricted because of the following problems: when each crystal grain (magnetic domain) is reduced in size to increase a recording density, the north poles and south poles of adjacent magnetic domains repel each other and result in cancellation of magnetization, so that it is necessary to reduce the thickness of the magnetic recording layer and the size the crystal grain in the perpendicular direction to obtain a high recording density, and finer crystal grains (smaller volumes) cause a phenomenon such as “thermal fluctuations” in which the magnetization direction of the crystal grains is disturbed by thermal energy and thus data is deleted.

In response to these problems, a “perpendicular magnetic recording method” has been studied. In this recording method, a magnetic recording layer is magnetized perpendicularly to a surface of a disk. Thus the north poles and the south poles are alternately combined and placed in a bit arrangement and the north poles and south poles of magnetic domains are adjacent to each other with enhanced magnetization. As a result, there are just a small number of self-demagnetizing fields (demagnetizing fields) in a bit and thus the magnetization (magnetic recording) is more stabilized. When the magnetization direction is recorded in the perpendicular direction, the demagnetizing fields of adjacent bits intensify each other. Thus unlike the longitudinal magnetic recording method, it is not necessary to reduce crystal grains in size in the perpendicular direction, so that it is not necessary to reduce the thickness of the magnetic recording layer. For this reason, even when crystal grains are reduced in size in the horizontal direction, the recording layer is increased in thickness and the crystal grains are increased in size in the perpendicular direction, so that the overall crystal grains increase in volume and can reduce the influence of “thermal fluctuations”.

In other words, in the perpendicular magnetic recording method, demagnetizing fields can be reduced and a KᵤV value (Kᵤ represents the crystal magnetic anisotropic energy of the magnetic recording layer and V represents a unit recording bit volume) can be obtained. Thus unstableness of magnetization due to “thermal fluctuations” can be reduced and the limit of a recording density can be greatly expanded. For this reason, the perpendicular magnetic recording method is expected to achieve super high density recording.

FIG. 2 is a sectional view schematically showing a basic layered structure of a hard disk acting as a “perpendicular two-layer magnetic recording medium” in which a recording layer for perpendicular magnetic recording is provided on a soft magnetic under layer (SUL). A soft magnetic under layer (SUL) 12, a magnetic recording layer 13, a protective layer 14, and a lubricating layer 15 are sequentially stacked on a non-magnetic substrate 11. In this structure, the soft magnetic under layer 12 effectively acts to increase writing magnetic fields and reduce demagnetizing fields of the magnetic recording layer 13. Permalloy, CoZrTa amorphous, and so on are typically used for the soft magnetic under layer 12. For the magnetic recording layer 13, a CoCr alloy, a multilayer film in which several layers of a PtCo layer and an ultrathin film of Pd and Co are alternately stacked, or a SmCo amorphous film or the like is used.

As shown in FIG. 2, in a hard disk of the perpendicular magnetic recording method, the soft magnetic under layer 12 is provided as the base of the magnetic recording layer 13. The soft magnetic under layer 12 has a magnetic property of “soft magnetism” and has a thickness of about 100 nm to 500 nm. The soft magnetic under layer 12 is provided to increase writing magnetic fields and reduce the demagnetizing fields of the magnetic recording film. The soft magnetic under layer 12 acts as a path of a magnetic flux from the magnetic recording layer 13 and acts as a path of a writing magnetic flux from a recording head. In other words, the soft magnetic under layer 12 plays the same role as an iron yoke in a permanent magnet magnetic circuit. Thus in order to avoid magnetic saturation during writing, the thickness of the soft magnetic under layer 12 has to be set larger than that of the magnetic recording layer 13.

In view of the multilayer configuration, the soft magnetic under layer 12 corresponds to the non-magnetic Cr base layer 2 provided in the hard disk of the longitudinal magnetic recording method shown in FIG. 1. However, the soft magnetic under layer 12 is not formed as easily as the Cr base layer 2.

As described above, in the hard disk of the longitudinal magnetic recording method, each layer is not more than 20 nm in thickness and is formed by a dry process (mainly magnetron sputtering, see patent document 1). Also for perpendicular two-layer recording media, various methods of forming the magnetic recording layer 13 and the soft magnetic under layer 12 by the dry process have been studied. When the soft magnetic under layer 12 is formed by the dry process, a sputtering target has to be a ferromagnetic material having strong saturation magnetization and the soft magnetic under layer 12 has to be 100 nm or larger in thickness. For this reason, perpendicular two-layer recording media have serious problems of mass production and productivity in consideration of the evenness of the film thickness and composition, the life of the target, the stability of the process, and the low deposition rate above all.

Further, for a higher recording density, it is necessary to minimize the flying height of a magnetic head which floats above a surface of a magnetic disk. However, a relatively thick film formed by the dry process is apt to have low surface smoothness and causes head crash.

For this reason, attempts have been made to form the soft magnetic under layer 12 by a plating method which can easily increase the thickness and enable polishing.

However, when the soft magnetic layer is formed by the plating method, a number of magnetic domains appear which are magnetized in a specific direction over a range of several millimeters to several centimeters in the plane of a plating film making up the soft magnetic layer, and domain walls appear on the interfaces of the magnetic domains. When the soft magnetic layer having such domain walls is used as a soft magnetic under layer for a perpendicular two-layer magnetic recording medium, a leakage magnetic field generated from the domain walls causes isolated pulse noise called spike noise or micro-spike noise, so that the signal reproduction characteristics may seriously deteriorate.

In order to achieve a perpendicular two-layer magnetic recording medium having excellent characteristics by a simple method, a number of studies have been conducted on film-forming conditions for forming a soft magnetic under layer by the plating method and the kinds of soft magnetic film suitable as a soft magnetic under layer, and it has been found that the occurrence of domain walls is reduced in the soft magnetic film and noise is effectively reduced by using, as a backing layer, a soft magnetic film which is formed of an alloy of two or more metals selected from the group consisting of Co, Ni, and Fe by an electroless plating method on a substrate forming a magnetic recording medium. The soft magnetic film has a coercive force of less than 20 oersteds (Oe) on a plane parallel to the layer and has magnetic anisotropy in which the ratio of saturation magnetization to residual magnetization is 4:1 to 4:3 (patent document 2: Japanese Patent Laid-Open No. 2005-108407).

In the plating method disclosed in patent document 2, the plating deposition rate of a soft magnetic film and a ratio of the plating deposition rate of the soft magnetic film to the velocity of a plating solution on a surface of a plating substrate are controlled, and the structure of the soft magnetic film is controlled by forming the film while causing the substrate to rotate on its axis and revolve in the plating solution.

However, a mechanism is not quite clear on why the soft magnetic film having the above magnetic anisotropy can be obtained by the condition setting described in patent document 2. Thus even with this film forming method, it is not easy to control the degree of the magnetic anisotropy of the soft magnetic film and obtain predetermined magnetic anisotropy with high reproducibility.

Incidentally, it is conventionally known that when a soft magnetic film is formed and then heat-treated in a magnetic field, the soft magnetic film can be provided with magnetic anisotropy. The magnetic anisotropy obtained by this technique serves as the application direction of the magnetic field, achieving high controllability. For this reason, as a technique for providing magnetic anisotropy for GMR and TMR heads having spin valve structures, there has been widely used a method of heat-treating a soft magnetic film while generating a magnetic field in a fixed direction (for example, see [0030] of patent document 3 (Japanese Patent Laid-Open No. 2005-240162)).

The magnetic anisotropy of a soft magnetic film obtained by such magnetic field heat treatment is limited to the application direction of the magnetic field. In order to form a film as the soft magnetic under layer of a perpendicular two-layer magnetic recording medium, magnetic anisotropy is necessary in the radial direction or the circumferential direction in the plane of a substrate and the magnetic anisotropy has to be symmetric with respect to the axis of the substrate. For this reason, there has been no report that a soft magnetic film having magnetic anisotropy suitable for the soft magnetic under layer of a perpendicular two-layer magnetic recording medium has been obtained by conventional techniques of magnetic field heat treatment.

For example, patent document 4 (Japanese Patent Laid-Open No. 6-89422) and patent document 5 (Japanese Patent Laid-Open No. 2001-284154) disclose that by performing heat treatment while applying a magnetic field in the magnetic difficult axis direction of an anisotropic soft magnetic film CoFeNi having been plated in a magnetic field, the direction of the anisotropy of the soft magnetic film is changed in the direction of the magnetic field heat treatment and the magnetic permeability is increased. Further, patent documents 4 and 5 disclose a method of fabricating a magnetic film by using a technique of applying a magnetic field to an electroplating soft magnetic film CoFeNi in the in-plane direction of the film and heat-treating the film while rotating the film. In the inventions disclosed in patent documents 4 and 5, the anisotropy of the soft magnetic film is disturbed by rotation in a magnetic field (practically equivalent to the application of a rotating magnetic field) to obtain magnetic isotropy, the soft magnetic properties are improved, and the soft magnetic film is used as a magnetic head core.

Moreover, as described in non-patent document 1 (Soshin, Chikazumi, “Physics of Ferromagnetic Material” vol. two, pp. 56 to 106 (Shokabo Publishing Co., Ltd., 1984), soft magnetic properties can be improved by providing anisotropy in the application direction of a magnetic field through magnetic field heat treatment, or applying a rotating magnetic field to obtain magnetic isotropy. Such properties are well known as induced magnetic anisotropy.

However, there has been no report on a technique of providing substantially axisymmetric anisotropy in the radial direction or the circumferential direction of a soft magnetic under layer through magnetic field heat treatment, for use in perpendicular magnetic media. Thus such a technique is not known.

### SUMMARY OF THE INVENTION

The present invention is designed in view of this problem. An object of the present invention is to provide a substrate suitable for the fabrication of a perpendicular magnetic recording medium having excellent signal generation characteristics with low noise, wherein magnetic anisotropy is provided in the in-plane radial direction or circumferential direction of a soft magnetic film formed by a plating method and the magnetic anisotropy is symmetric with respect to the axis of the substrate.

In order to solve the problem, a first invention is a substrate for a magnetic recording medium, the substrate including a non-magnetic substrate shaped like a disk having a diameter of 90 mm or less and a soft magnetic under layer provided on the major surface of the substrate, wherein the soft magnetic under layer is a plating layer mainly composed of at least two elements selected from the group consisting of Co, Ni, and Fe, the plating layer has magnetic anisotropy provided by magnetic field heat treatment after film formation, the magnetic anisotropy is obtained with a difference (δH=H_{d}−H_{c}) of 5 oersteds (Oe) or more in terms of absolute value between a magnetization saturation magnetic field strength (H_{d}) in the in-plane radial direction and a magnetization saturation magnetic field strength (H_{c}) in the in-plane circumferential direction, and the magnetic anisotropy is symmetric with respect to the axis of the substrate.

It is preferable that the plating layer contains at least one element selected from the group consisting of B, C, P and S.

Further, it is preferable that the non-magnetic substrate is a silicon wafer and a base plating layer made of Ni or NiP is provided between the major surface of the substrate and the plating layer.

According to a magnetic recording medium of the present invention, a magnetic recording layer is provided on the soft magnetic under layer of the substrate for a magnetic recording medium.

A second invention is a method of fabricating a substrate for a magnetic recording medium, the method including: an electroless plating step of forming a soft magnetic film on the major surface of a non-magnetic substrate shaped like a disk having a diameter of 90 mm or less, and a step of performing magnetic field heat treatment on the soft magnetic film formed by the electroless plating step, wherein in the electroless plating step, the soft magnetic film is formed by plating in which the substrate is dipped into a plating solution containing at least two metal ions selected from the group consisting of Co, Ni, and Fe, and the magnetic field heat treatment step is performed such that magnetic anisotropy is obtained with a difference (δH=H_{d}−H_{c}) of 5 oersteds (Oe) or more in terms of absolute value between a magnetization saturation magnetic field strength (H_{d}) in the in-plane radial direction of the soft magnetic film and a magnetization saturation magnetic field strength (H_{c}) in the in-plane circumferential direction of the soft magnetic film and the magnetic anisotropy is symmetric with respect to the axis of the substrate.

It is preferable that in the magnetic field heat treatment, the heat treatment temperature is 150° C. to 350° C., a magnetic field applied to the substrate has a strength of 50 oersteds (Oe) or more, and the treatment time is selected within a range of five minutes to ten hours.

Further, it is preferable that magnetic field application means is used in the magnetic field heat treatment, the magnetic field application means being capable of obtaining a magnetic field application area on a surface of the soft magnetic film as large as or larger than one twentieth of the area of the soft magnetic film, and a magnetic field is applied while at least one of the non-magnetic substrate and the magnetic field application means is rotated about the axis of the substrate.

Moreover, it is preferable that a silicon wafer is selected as the substrate and the method further includes, before the electroless plating step, a step of forming a base plating layer made of Ni or NiP by dipping the silicon wafer into a plating bath containing Ni ions or a plating bath obtained by adding a phosphorus reducing agent to a bath containing Ni ions.

Further, it is preferable that the method further includes, before the step of forming the base plating layer, a substrate surface treatment step of removing an oxide film on a surface of the silicon wafer.

The method of fabricating the substrate for a magnetic recording medium may include a polishing step of controlling the thickness and surface smoothness of the soft magnetic film after the soft magnetic film is formed by plating.

According to the present invention, the soft magnetic film formed by the plating method is provided with magnetic anisotropy in the in-plane radial direction or circumferential direction and the magnetic anisotropy can be symmetric with respect to the axis of the substrate, thereby suppressing the occurrence of domain walls in the soft magnetic under layer. Besides, the degree of magnetic anisotropy is highly controllable and reproducible. With the soft magnetic under layer formed thus, it is possible to provide a substrate suitable for fabricating a perpendicular magnetic recording medium having excellent signal generation characteristics with low noise.

Therefore, with a hard disk including a magnetic film for perpendicular magnetic recording on the soft magnetic under layer, it is possible to obtain a magnetic recording medium having a high recording density with an excellent writing property due to an increase of a head flux.

Further, in the substrate for a magnetic recording medium of the present invention, the soft magnetic under layer is formed by wet electroless plating. It is thus possible to remarkably simplify the fabrication process as compared with the film formation of a dry process such as vapor deposition and achieve high productivity.

In the magnetic field heat treatment of patent document 3, magnetic anisotropy is provided only in a specific direction of the soft magnetic film and the anisotropy is not symmetric with respect to the axis of the substrate, whereas in the present invention, the magnetic anisotropy is symmetric with respect to the axis of the substrate and the anisotropy is freely (arbitrarily) selected between the circumferential direction and the radial direction of the substrate.

### BRIEF DESCRIPTION OF THE DRAWINGS

FIG. 1 is a sectional view schematically showing a typical multilayer structure of a hard disk of a longitudinal magnetic recording method;

FIG. 2 is a sectional view schematically showing a basic layered structure of a perpendicular two-layer magnetic recording medium in which a recording layer for perpendicular magnetic recording is provided on a soft magnetic under layer;

FIG. 3 is a sectional view schematically showing a basic layered structure of a perpendicular two-layer magnetic recording medium in which a Si substrate is used as a non-magnetic substrate and a base plating layer (nucleation film) is provided;

FIG. 4 is a conceptual rendering showing magnetization curves in the in-plane circumferential direction and radial direction, the conceptual rendering explaining the meaning of the magnetic anisotropy of the soft magnetic under layer provided on a substrate for a magnetic recording medium of the present invention;

FIGS. 5A and 5B illustrate a state of the application of a magnetic field usable in magnetic field heat treatment;

FIGS. 6A and 6B explain the outline of the configuration of a magnet field generator used for applying a magnetic field in an example, FIG. 6A is a top view, FIG. 6B is a sectional view taken along line b-b′ of FIG. 6A; and

FIG. 7 illustrates the evaluation results of the magnetic anisotropy of the soft magnetic under layer, the magnetic anisotropy being evaluated in the plane of the substrate after the heat treatment for stabilizing the magnetic properties is performed on a soft magnetic under layer of Example 2.

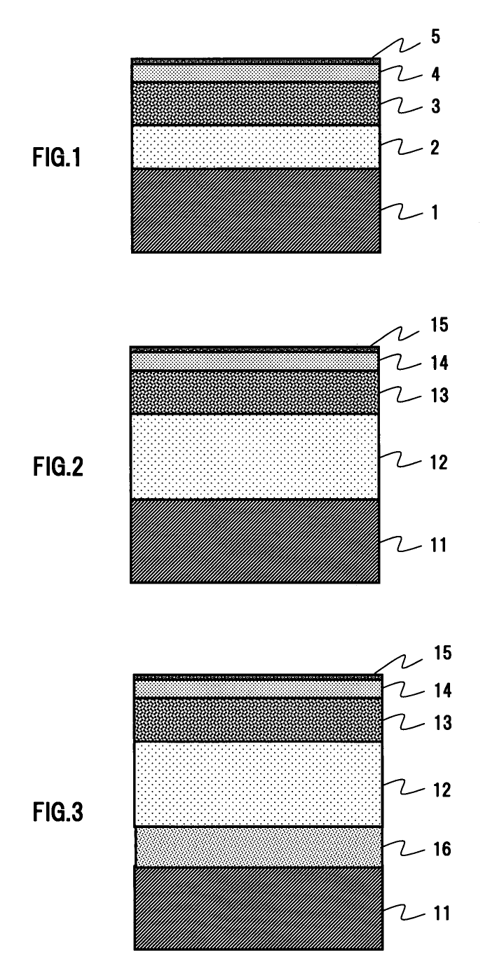

### DETAILED DESCRIPTION OF THE PREFERRED EMBODIMENTS

An embodiment for implementing the present invention will now be specifically described below with reference to the accompanying drawings.

A substrate for a magnetic recording medium of the present invention is provided for perpendicular magnetic recording. A hard disk serving as a perpendicular two-layer magnetic recording medium can be obtained by forming a magnetic recording layer on a soft magnetic under layer. To be specific, in the substrate for a magnetic recording medium of the present invention, as shown in FIG. 2, a soft magnetic under layer 12 formed by electroless plating is provided on a non-magnetic substrate 11. Further, a magnetic recording layer 13 for perpendicular magnetic recording is formed on the soft magnetic under layer 12, and a protective layer 14 and a lubricating layer 15 are sequentially stacked thereon, so that the magnetic recording medium of the present invention is obtained. As shown in FIG. 3, when a Si substrate is used as the non-magnetic substrate 11, a nucleation film 16 made of Ni or NiP for obtaining adhesion to the substrate can be formed by plating between the non-magnetic substrate 11 and the soft magnetic under layer 12.

The configurations of the layers will be described in order.

[Non-magnetic substrate 11]: A non-magnetic substrate used for the substrate for the magnetic recording medium of the present invention may be a substrate or a glass substrate which is formed by Ni—P electroless plating on an aluminum substrate conventionally used for the fabrication of magnetic recording media. Further, a Si substrate may be used. When using a glass substrate, it is necessary to apply a conductive film beforehand by a sputtering method and so on.

The Si substrate does not always have to be a single-crystal substrate. However, the use of a single-crystal Si substrate is advantageous in that an even in-plane atomic arrangement is obtained on a surface of the substrate and an in-plane surface chemical state and an in-plane surface potential state are made uniform in a plating step. In other words, a single-crystal Si substrate used as the non-magnetic substrate 11 is advantageous in that direct displacement plating can be performed on the single-crystal Si substrate 11 during the formation of the nucleation film 16 made of Ni or NiP (described later) and magnetic unevenness caused by uneven plating can be suppressed because single-crystal Si has extremely uniform and high-quality crystallinity.

In the following explanation, the non-magnetic substrate 11 is a single-crystal Si substrate.

A single-crystal Si substrate formed by crystal breeding according to the Czochralski method (CZ) or the floating zone method (FZ) is readily available. The plane direction of the Si substrate is not particularly limited and thus any plane direction including (100), (110) and (111) may be used. Further, unlike a substrate for fabricating a semiconductor device, the impurity level of the Si substrate is not strictly limited and thus the substrate may contain an impurity (a donor, an acceptor, or a light element including oxygen, carbon, and nitrogen) with an atomic percent of about 10% (to 10²² atoms/cm³) relative to Si.

In the present invention, the substrate is 90 mm or less in diameter regardless of whether the non-magnetic substrate 11 is a single-crystal Si substrate or not. This diameter is set to form a uniform flow of a plating solution on the surface of the substrate in the step of electrolytic plating of the soft magnetic under layer 12 (described later). This point will be discussed later.

[Surface treatment of the Si substrate]: As described above, when a Si substrate is used as the non-magnetic substrate 11 of the present invention, the nucleation film 16 serving as a base plating layer is provided between the Si substrate 11 and the soft magnetic under layer 12. Thus, before the nucleation film 16 is formed by plating, the surface of the Si substrate 11 is activated. The surface activation facilitates the subsequent displacement plating of the nucleation film, increasing the adhesion of the film.

In the surface activation, an oxide film having been naturally formed on the surface of the Si substrate 11 is mainly removed. In this process, Si atoms on the extreme surface of the Si substrate 11 are etched and the surface of the substrate is chemically activated.

The etching can be performed by various methods such as acid treatment (hydrofluoric acid, hydrochloric acid, nitric acid, and so on), alkali treatment (NaOH, KOH, ammonia, and so on), and electrolysis. For example, in the case of etching using an alkaline solution including caustic soda, a solution containing a 2 to 60 weight percent concentration of alkali is set at 30° C. to 100° C., the surface oxide film of the Si substrate is removed, and the surface of the Si substrate is slightly corroded.

[Nucleation film 16]: The nucleation film 16 is formed by displacement plating of Ni or NiP on the surface of the Si substrate having been subjected to the surface activation. When the nucleation film 16 is a Ni layer, a plating solution containing Ni ions of 0.01 N or more as elements is used. The plating solution preferably contains Ni ions of 0.05 N to 0.3 N. The Si substrate 11 is dipped into the plating solution to form the nucleation film 16 by plating. When the nucleation film 16 is a NiP layer, a phosphorus (P) reducing agent (hypophosphorous acid, sodium hypophosphite, and so on) is added to the plating solution to form the nucleation film 16 by plating. The surfaces of the Ni layer and NiP layer obtained thus may be modified by a Cu film, a Pd film, or an Au film.

The nucleation film 16 is preferably 10 nm to 1000 nm in thickness and more preferably 50 nm to 500 nm in thickness. This is because the nucleation film 16 having a thickness smaller than 10 nm is apt to cause uneven grain size of polycrystal of a metal (alloy) and the base plating layer 16 having a thickness larger than 1000 nm increases crystal grains in size, which is not preferable to a base plating layer.

[Soft magnetic under layer 12]: The soft magnetic under layer 12 is formed by an ordinary method known as electroless plating. For example, a film is formed with a thickness of 100 nm to 3 μm by plating, and then the plating film is polished to a predetermined thickness of 50 nm to 1000 nm. This polishing step is performed using inorganic particulates of silica, ceria, and so on and surf ace roughness is controlled concurrently with the adjustment of the thickness.

The thickness of the soft magnetic under layer 12 is set at 50 nm to 1000 nm for the following reason: when the thickness of the soft magnetic under layer 12 is larger than 1000 nm, magnetic noise generated from the soft magnetic under layer 12 increases during the signal reproduction of the hard disk, so that the S/N characteristics of the recording medium are apt to deteriorate. When the thickness of the soft magnetic under layer 12 is less than 50 nm, the magnetic recording layer 13 has an insufficient magnetic transmission property as a base layer, so that the overwrite property of the recording medium deteriorates.

Any one of a sulfide bath and a chloride bath can be used as an electroless plating bath. Various kinds of metal may be contained in the bath. Since the plating film has to demonstrate the magnetic properties of a soft magnetic film and the crystal structure has to be a cubic crystal structure, a plating bath containing a metallic salt including at least two elements selected from the group consisting of Co, Ni, and Fe is selected. These metallic elements are selected because an excellent soft magnetic property is hard to obtain in a plating film of a single element, though electroless plating can be performed with Co, Ni and Fe.

To be specific, the bath composition includes, for example, a mixed bath of nickel sulfate and cobalt sulfate or a bath obtained by mixing the mixed bath with ferrous sulfate. The concentration of a metallic salt in the mixed bath is preferably set at 0.01 N to 0.5 N. Further, a reducing agent corresponding to a metal ion contained in the bath is added to the plating bath when necessary. Such a reducing agent includes, for example, hypophosphorous acid (H₂PO₂) and dimethylamine borane (DMAB:(CH₃)₂HNBH₃).

Since the soft magnetic under layer of the present invention is formed by electroless plating, light elements contained in the plating bath or the reducing agent are captured into the film. Of these light elements, particularly boron (B), phosphorus (P), carbon (C) and sulfur (S) affect the soft magnetic properties. The soft magnetic under layer is formed to significantly contain at least one element of the four light elements. The plating film significantly containing at least one element of B, C, P and S is a major point of difference from a dry film-formation method such as sputtering.

When the diameter of the substrate to be plated exceeds 90 mm, it is difficult to form an even flow of the plating solution on the surface of the substrate. Therefore, in the present invention, the diameter of the non-magnetic substrate 11 is set at 90 mm or less to form an even flow of the plating solution on the surface of the substrate. Further, in order to form an even flow of the plating solution, the following methods are also effective: a liquid circulation is adjusted during plating, the plating solution is stirred with a stirring bar such as a paddle, or the substrate to be plated is caused to revolve or rotate on its axis, so that a liquid flow in the plating bath is adjusted. Of these methods, the method of causing the substrate to be plated to revolve or rotate on its axis in the bath is a simple and effective way for obtaining a proper flow velocity. Therefore, a liquid flow in the plating bath is preferably adjusted by properly combining the revolution and rotation of the substrate to be plated in the bath with the circulation and stirring of the plating solution. According to the experimental results of the inventors et al., the velocity of revolution and rotation is preferably set at 10 rpm to 100 rpm and more preferably set at 20 rpm to 80 rpm.

[Magnetic field heat treatment performed on the soft magnetic under layer]: The soft magnetic under layer formed by plating is subjected to magnetic field heat treatment under the temperature conditions and the magnetic field application conditions (described later), and magnetic anisotropy is provided by applying a magnetic field and performing heat treatment. Further, through the magnetic field heat treatment of the present invention, the soft magnetic film is provided with magnetic anisotropy in the in-plane radial direction or circumferential direction. The magnetic anisotropy is symmetric with respect to the axis of the substrate.

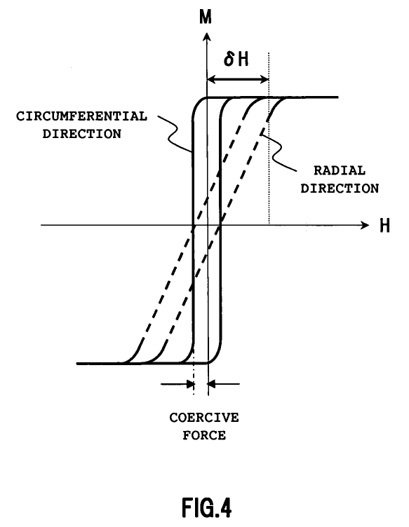

In this case, “magnetic anisotropy” means a difference between a magnetization saturation magnetic field strength (H_{d}) in the in-plane radial direction and a magnetization saturation magnetic field strength (H_{c}) in the in-plane circumferential direction. For example, the magnetic anisotropy (Hₖ) is evaluated by δH=H_{d}−H_{c} indicated by magnetization curves in the conceptual illustration of FIG. 4. When δH is positive (H_{d}−H_{c}>0), the in-plane radial direction is the magnetization direction (anisotropy direction). When δH is negative (H_{d}−H_{c}<0), the in-plane circumferential direction is the magnetization direction (anisotropy direction). Therefore, the numeric value of magnetic anisotropy is indicated by an absolute value.

The upper limit temperature of the magnetic field heat treatment is selected at 350° C. or lower in the present invention. This is because when the temperature of the magnetic field heat treatment exceeds 350° C., soft magnetic crystal grains grow in size and thus the magnetic properties and magnetic anisotropy are apt to deteriorate. When the temperature of the magnetic field heat treatment is lower than 150° C., it is difficult to sufficiently provide thermal energy required for producing magnetic anisotropy on the soft magnetic film. Therefore, it is desirable to set the temperature range of the magnetic field heat treatment at 150° C. to 350° C. In view of sufficient suppression on the enlargement of soft magnetic crystal grains, the temperature range is preferably set at 150° C. to 250° C.

The heat treatment time is set according to the strength or the like of an applied magnetic field. The retention time at the highest temperature of heat treatment is at least five minutes. A retention time less than 5 minutes at the highest temperature is not preferable because it becomes difficult to obtain a uniform in-plane temperature on the substrate (soft magnetic under layer). On the other hand, a long retention time exceeding 10 hours is not desirable because productivity considerably decreases. Therefore, the heat treatment time is preferably set at 5 minutes to 10 hours. For example, the heat treatment time is selected within a range from 30 minutes to 2 hours.

The magnetic field heat treatment of the present invention is performed in a magnetic field described below. First, means for generating a magnetic field may be any one of a permanent magnet, an electromagnet, and a superconducting magnet. In order to arbitrarily control the direction of a magnetic field applied to the soft magnetic under layer, a magnetic circuit of a permanent magnet is the best.

The applied magnetic field is strong enough to provide the soft magnetic under layer with magnetic anisotropy of 5 oersteds (Oe) or higher. When the soft magnetic under layer has magnetic anisotropy of 5 oersteds (Oe) or higher, it is possible to effectively suppress spike noise and the like generated from the soft magnetic under layer. Magnetic anisotropy of 12 oersteds (Oe) or higher is more preferable. The higher the magnetic anisotropy is provided for the soft magnetic under layer, the higher the noise reduction. Since it is difficult to provide magnetic anisotropy exceeding 2 kilooersteds (kOe) in the process of magnetic field heat treatment, practically the soft magnetic under layer is provided with magnetic anisotropy of 5 oersteds (Oe) to 2 kilooersteds (kOe).

To be specific, the strength of an applied magnetic field is selected such that a magnetic field on a surface of the soft magnetic under layer has a strength of 50 oersteds (Oe) or higher. This is because when an effective magnetic field applied to the soft magnetic under layer has a strength less than 50 oersteds (Oe), anisotropy is low or it is hard to produce anisotropy in the soft magnetic under layer. For example, in the same magnetic field environment as a spatial magnetic field, a magnetic field of 50 Oe to 10 kOe, preferably 100 Oe to 5 kOe, is generated and applied to the soft magnetic under layer. The stronger the applied magnetic field, the better. Since a magnetic field generated by a permanent magnet has a strength not more than the residual magnetization (Br) of the magnet, practically the upper limit is about 10 kOe.

The conditions of such magnetic field heat treatment can be easily set, so that the degree of obtained magnetic anisotropy is highly controllable and reproducible. It is not always necessary to perform the magnetic field heat treatment of the present invention in a state in which a fixed magnetic field is applied over the surface of the soft magnetic layer all the time.

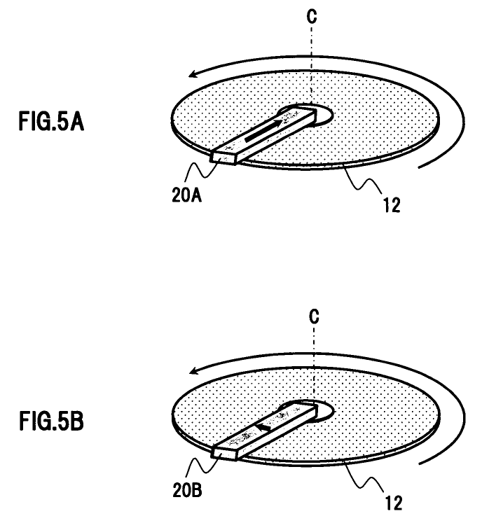

FIGS. 5A and 5B illustrate a state of the application of a magnetic field usable in magnetic field heat treatment. Reference numerals 20A and 20B denote magnetic field application parts, each being made up of a relatively small permanent magnet magnetic circuit. The magnetization directions (that is, the magnetic field directions) are indicated by arrows.

The magnetic field application part 20A of FIG. 5A generates a magnetic field in the radial direction of the soft magnetic under layer 12. The soft magnetic under layer 12 rotates about the axis (C) of the substrate, so that the magnetic field is applied over the surface of the substrate in terms of time average. The magnetic field application part 20B of FIG. 5B generates a magnetic field in the circumferential direction of the soft magnetic under layer 12. The soft magnetic under layer 12 rotates about the axis (C) of the substrate, so that the magnetic field is similarly applied over the surface of the substrate in terms of time average. When a magnetic field is applied, as shown in FIG. 5A, by using the magnetic field application part 20A for generating a magnetic field in the radial direction of the soft magnetic under layer 12, magnetic anisotropy is provided for the magnetization curve of the radial direction in the plane of the substrate. When a magnetic field is applied, as shown in FIG. 5B, by using the magnetic field application part 20B for generating a magnetic field in the circumferential direction of the soft magnetic under layer 12, magnetic anisotropy is provided for the magnetization curve of the circumferential direction in the plane of the substrate.

The sizes of the magnetic field application parts 20A and 20B are selected such that an effective magnetic field application area formed by the magnetic field application part on the soft magnetic under layer is one twentieth of the area of the soft magnetic under layer or larger. This is because when the effective magnetic field application area is smaller than one twentieth, it is difficult to obtain the effective strength of a magnetic field applied to the soft magnetic under layer. Instead of the substrate, the magnetic field application part may be rotated. In other words, a magnetic field may be applied while at least one of the substrate and the magnetic field application part is rotated about the axis of the substrate.

In the case where a large magnetic field application device is used to apply a fixed magnetic field (symmetric with respect to the radial direction or the circumferential direction) over the surface of the soft magnetic under layer all the time, the rotations of the substrate in FIGS. 5A and 5B are not always necessary. However, when a magnetic field strength is varied, in order to achieve in-plane uniformity of an effective magnetic field strength on the soft magnetic under layer and assure symmetry with respect to the axis of the substrate, it is desirable to apply a magnetic field while at least one of the substrate and the magnetic field application device is rotated about the axis of the substrate and the axis of the magnetic field in a state in which the axis of the substrate and the axis of the magnetic field are caused to substantially agree with each other. In this case, the number of revolutions is not particularly limited. When the substrate and the magnetic field application device have a relative rpm of 5 rpm or higher, substantially axisymmetric magnetic anisotropy can be provided. Thus the rpm is controlled, for example, between 10 rpm and 100 rpm inclusive.

[‘Magnetic anisotropy’ of the soft magnetic under layer 12]: The above magnetic field heat treatment provides the soft magnetic under layer with magnetic anisotropy as will be described below. Although [0049] of patent document 3 describes plating in a magnetic field, such plating in a magnetic field is not always necessary in the present invention.

Magnetic anisotropy is measured (actually a magnetization curve is measured) mainly by a VSM (Vibrating Sample Magnetometer) or the Kerr effect. A VSM makes it possible to strictly determine a magnetization curve including an absolute value of magnetization. However, it is necessary to cut out a measurement sample, so that destructive testing is not avoidable. Further, the magnetic property is undeniably affected by a state of a residual stress of the soft magnetic film because the state is different from that of a nondestructive state.

On the other hand, the Kerr effect makes it possible to measure a magnetization curve in a nondestructive manner and achieve a small measurement area of about 2 mm to 3 mm, thereby facilitating multipoint measurement for obtaining in-plane distribution. However, the vertical axis of an obtained magnetization curve originally represents a Kerr rotation angle. Thus it is not possible to recognize an absolute value of magnetization. Further, since the Kerr effect is measured using visible light reflected on a surface of a film, the measurement result is unavoidably based on information on the extreme surface of the film. Thus it is undeniable that the result may be different from the magnetization curve in the overall thickness direction of the film.

As described above, each method of measurement has peculiar characteristics. It is important to properly use these methods when acquiring information on magnetic anisotropy.

[Magnetic recording layer 13]: The magnetic recording layer 13 provided on the soft magnetic under layer 12 is made of a hard magnetic material for performing perpendicular magnetic recording. Although the magnetic recording layer 13 may be directly formed on the soft magnetic under layer 12, various intermediate films may be provided as necessary for matching between the crystal grain size and the magnetic properties, and then the magnetic recording layer 13 may be formed on the intermediate films. The intermediate film is, for example, a Ru film. An intermediate film including two or more layers may be stacked.

The composition of the magnetic recording layer 13 is not particularly limited as long as the magnetic recording layer 13 is made of a hard magnetic material capable of forming magnetic domains which are easily magnetized perpendicularly to a layer surface. When the magnetic recording layer 13 is formed by the sputtering method, for example, a Co—Cr alloy film, an Fe—Pt alloy film, a CoCr—Si granular film, a Co/Pd multilayer film, and so on can be used. When the magnetic recording layer 13 is formed by a wet process, for example, a Co—Ni plating film, a coating film made of barium ferrite having a magnetoplumbite phase, and so on can be used.

The magnetic recording layer 13 formed thus is preferably about 5 nm to 100 nm in thickness and more preferably about 10 nm to 50 nm in thickness. Further, the magnetic recording layer 13 is preferably formed to have a coercive force of 0.5 to 10 kilooersteds (kOe), more preferably 3 to 6 kilooersteds (kOe).

[Protective layer 14 and lubricating layer 15]: The protective layer 14 on the top surface of the magnetic recording layer 13 can be formed of materials having been used in conventional magnetic recording media. For example, an amorphous carbon protective film formed by the sputtering method or CVD and a crystalline carbon protective film and the like can be used. The lubricating layer 15 on the top surface of the protective layer 14 can be also formed by applying materials having been used in conventional magnetic recording media. The kind of material and the applying method are not particularly limited. For example, the lubricating layer 15 is formed by applying fluorine oil to form a monomolecular film. The protective layer 14 and the lubricating layer 15 are, for example, about 2 nm to 20 nm in thickness.

The present invention will be more specifically described below in accordance with the following examples. The present invention is not limited to these examples.

### EXAMPLES

In the present example, a single-crystal Si substrate was used as a non-magnetic substrate. Coring, centering, and lapping were performed to obtain a Si single crystal plate (100) having a diameter of 65 mm (n-type doped with P) from a Si single crystal. The Si single crystal had been obtained by crystal breeding according to the CZ method and had a diameter of 200 nm (8 inches). Both sides of the Si single crystal plate were polished using slurry containing colloidal silica having an average grain size of 15 nm, and a Si substrate was obtained with a surface roughness (Rms) of 4 nm. Rms represents a root mean square roughness which was measured using an AFM (automatic force microscope).

The Si substrate was dipped into a caustic soda solution having 2 mass percent (45° C.) for three minutes to remove a thin surface oxide film on the substrate, surface activation was performed to etch Si on the extreme surface, and then the substrate was dipped for five minutes into a base plating bath having been prepared by adding ammonium sulfate of 0.5 N to a nicotine sulfate solution of 0.1 N and keeping the bath at 80° C., so that a base Ni plating layer (200 nm) serving as a nucleation film was obtained. When sodium hypophosphite (about 0.01 N to 0.05 N) was mixed with a nucleation solution and nucleation was performed therein, a NiP layer was obtained as a nucleation layer.

Next, a plating solution containing ammonium sulfate of 0.2 N, nickel sulfate of 0.02 N, cobalt sulfate of 0.1 N, iron sulfate of 0.01 N, and dimethylamine borane of 0.04 N as a reducing agent was prepared and the solution was heated and kept at 65° C. The temperature of the solution was kept at 65° C. to have a film deposition rate of 0.1 μm/min during the electroless plating of a soft magnetic under layer.

Under these conditions, a substrate to be plated was subjected to electroless plating for 20 minutes while being rotated on its axis at 60 rpm. As a result, a soft magnetic film having a thickness of 1200 nm was obtained as a soft magnetic under layer. After the soft magnetic under layer was formed by plating, the soft magnetic under layer had a coercive force of 4.5 oersteds (Oe), so that an isotropic film was obtained with excellent soft magnetic properties. The soft magnetic film was polished with colloidal silica to have a thickness of 600 nm and smoothed to have a surface roughness of 0.25 nm in terms of Ra.

A substrate including the soft magnetic under layer obtained thus was stored in a furnace for magnetic field heat treatment in which the atmosphere is replaced with Ar gas substitute. A magnetic field was applied in the in-plane radial direction or circumferential direction of the substrate by using a magnetic field generator fabricated by a SmCo magnet, and heat treatment was performed in this state.

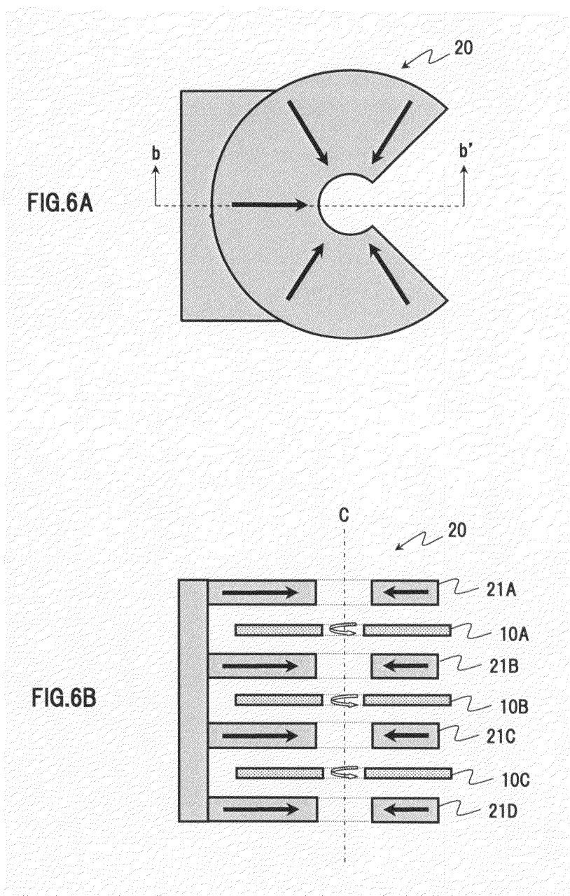

FIGS. 6A and 6B explain the outline of a structural example of the magnet field generator used for applying a magnetic field in the radial direction. FIG. 6A is a top view and FIG. 6B is a sectional view taken along line b-b′ of FIG. 6A. In a magnetic field generator 20, a plurality of SmCo magnets (21A to 21D) are stacked. Substrates 10 including the soft magnetic under layers are set in gaps provided between the SmCo magnets, and magnetic fields are applied to the substrates 10. A horizontal magnetic field in the radial direction is applied to about three fourths of the area of the substrate. The virtual center of the magnetic circuit and the axis of the substrate substantially agree with each other. The substrate can be rotated about the axis (C) of the substrate by a rotation mechanism (not shown) and a magnetic field is applied over the surface of the soft magnetic under layer by the rotation.

FIGS. 6A and 6B illustrate magnets for generating magnetic fields in the radial direction of the soft magnetic under layer. When a magnetic field is applied using a magnet which generates a magnetic field in the circumferential direction of the soft magnetic under layer, magnetic anisotropy is provided for a magnetization curve in the circumferential direction in the plane of the soft magnetic under layer. By using a magnetic circuit for applying a magnetic field in the circumferential direction in the present example, a magnetic field is always applied to about a half of the area of the substrate. By setting the gaps between the magnets such that the plurality of substrates 10 can be disposed between the magnets, magnetic field heat treatment can be performed while the plurality of substrates 10 are set in the gaps.

Tables 1 and 2 show the conditions of magnetic field heat treatment and the results of the magnetic properties (coercive force and magnetic anisotropy) of the soft magnetic under layer after each treatment. Table 1 shows the substrates of Examples 1 to 9 of the present invention in which the treatment temperature is selected from 150° C. to 350° C. Table 2 shows the substrates of Comparative Examples 1 and 2. In these examples, the strength of an applied magnetic field was controlled by adjusting the gaps between the magnets of the magnetic circuit and a magnetic field was applied while the substrates 10 were rotated about the axes of the substrates at about 30 rpm. A measurement sample was cut out in a predetermined size from each substrate and the magnetic properties were measured by a VSM.

TABLE 1

| | Treatment Temperature/Time and | Coercive | | |
|---|---|---|---|---|
| EXAMPLE | Magnetic Field Strength | Force | δH | Anisotropy |
| No. | (Magnetic Field Direction) | (Oe) | (Oe) | Direction |
| 1 | 150° C. × 2 Hr + 2 kOe (Radial | 4.0 | 14 | Radial |
| | Direction) | | | Direction |
| 2 | 150° C. × 1 Hr + 3 kOe | 4.5 | 15 | Circumferential |
| | (Circumferential Direction) | | | Direction |
| 3 | 200° C. × 1 Hr + 1 kOe (Radial | 3.5 | 27 | Radial |
| | Direction) | | | Direction |
| 4 | 200° C. × 1 Hr + 1 kOe | 3.5 | 26 | Circumferential |
| | (Circumferential Direction) | | | Direction |
| 5 | 250° C. × 30 min + 1 kOe | 2.5 | 29 | Circumferential |
| | (Circumferential Direction) | | | Direction |
| 6 | 250° C. × 30 min + 500 Oe (Radial | 3.0 | 23 | Radial |
| | Direction) | | | Direction |
| 7 | 250° C. × 30 min + 500 Oe | 3.0 | 22 | Circumferential |
| | (Circumferential Direction) | | | Direction |
| 8 | 300° C. × 30 min + 500 Oe (Radial | 3.5 | 19 | Radial |
| | Direction) | | | Direction |
| 9 | 300° C. × 10 min + 1 kOe | 4.0 | 16 | Circumferential |
| | (Circumferential Direction) | | | Direction |

TABLE 2

| | Treatment Temperature/Time and | Coercive | | |
|---|---|---|---|---|
| Comparative | Magnetic Field Strength | Force | | Anisotropy |
| Example No. | (Magnetic Field Direction) | (Oe) | δH (Oe) | Direction |
| 1 | 100° C. × 1 Hr + 2 kOe | 4.4 | 4.0 | Circumferential |
| | (Circumferential Direction) | | | Direction |
| 2 | 400° C. × 1 Hr + 2 kOe (Radial | 25.0 | 11.0 | Radial |
| | Direction) | | | Direction |

In the examples of the present invention shown in Table 1, each of the soft magnetic under layers of the substrates had a proper coercive force (2.5 to 4.5 oersteds) and proper magnetic anisotropy (δH: 14 to 29 oersteds), whereas in the comparative examples of Table 2, the soft magnetic under layers of the substrates demonstrated an undesirable magnetic property in at least one of coercive force and magnetic anisotropy.

To be specific, the soft magnetic under layer of Comparative Example 1 had a preferable coercive force (4.4 oersteds) but the degree of magnetic anisotropy was low (4.0 oersteds) and did not reach 5 oersteds required for effectively suppressing spike noise and the like generated from the soft magnetic under layer. Further, the soft magnetic under layer of Comparative Example 2 had preferable magnetic anisotropy of 11.0 oersteds but the coercive force was considerably increased by magnetic field heat treatment.

As described above, according to the present invention in which the temperature of magnetic heat treatment is selected within a proper range, it is possible to obtain a soft magnetic under layer required for effectively suppressing spike noise and the like.

A magnetic recording layer and so on were provided on the soft magnetic under layer having such magnetic properties and the magnetic properties of a perpendicular magnetic recording medium were evaluated. First, the soft magnetic under layer was polished by about 600 nm with slurry in which colloidal silica had been suspended, so that the soft magnetic under layer had a thickness of about 600 nm. The in-plane thickness distribution of the film after the polishing was evaluated by fluorescent X-rays. The thickness was distributed within several percents on the front side and back side, and the surface roughness (Rms) was 4 nm which was substantially equal to that of the surface of a Si substrate.

After the polishing, the surface of the soft magnetic under layer was subjected to precision cleaning and was heat-treated at 200° C. for one hour in a clean atmosphere (in an atmosphere of Ar gas mixed with 5% H₂). Since the heat treatment is performed to stabilize the magnetic properties, a magnetic field is not applied during the heat treatment.

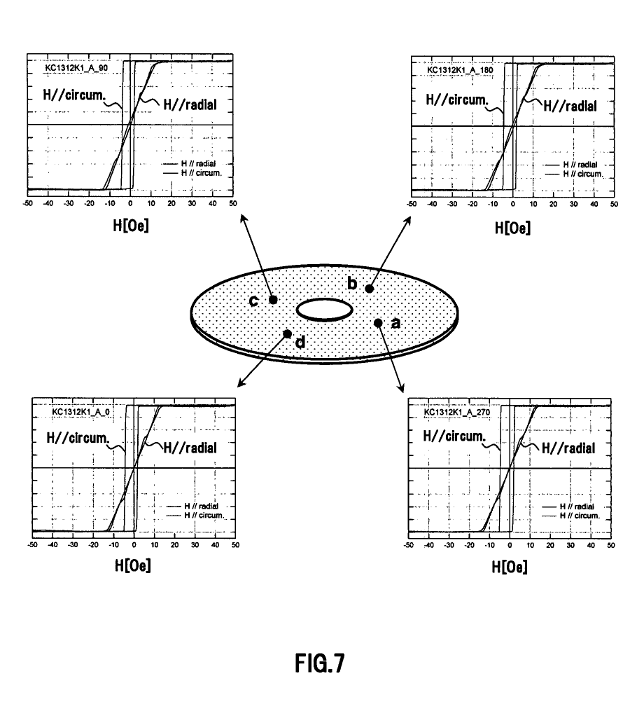

FIG. 7 illustrates the evaluation results of the magnetic anisotropy of the soft magnetic under layer of Example 2. The magnetic anisotropy was evaluated in the plane of the substrate after the heat treatment for stabilizing the magnetic properties was performed on the soft magnetic under layer. Hysteresis curves produced by the Kerr effect were measured on four points in the plane of the substrate. As shown in FIG. 7, the four points have substantially identical hysteresis curves, which means that the magnetic anisotropy is uniformly symmetric with respect to the axis in the plane (in this case, circumferential anisotropy). The soft magnetic under layers of the other examples 1, 3 to 9 were also evaluated in a similar manner. In any case, it was confirmed that the magnetic anisotropy was uniformly symmetric with respect to the axis in the plane.

Further, a magnetic recording layer for perpendicular magnetic recording was formed on the soft magnetic under layer by sputtering. The magnetic recording layer was obtained under the following sputtering conditions: in a state in which the substrate temperature was kept at 180° C., a Ru film having a thickness of 2 nm was first formed and a magnetic film having a thickness of 15 nm with a composition of Co Cr:Pt=76:19:5 (mass %) was formed on the Ru film. The magnetic recording layer has a coercive force of 4.5 kilooersteds (kOe) perpendicularly to a film surface and a coercive force of 500 oersteds (Oe) in parallel with the film surface.

The magnetic recording layer was coated with amorphous carbon having a thickness of 10 nm, and then a fluorine lubricating film was applied thereon by a dipping method, so that a perpendicular magnetic recording medium was obtained.

After the perpendicular magnetic recording medium was set on a spin stand and DC erased, writing was performed by a nano-slider head having a flying height of 10 nm and the noise level of a playback signal was measured. As a result, no spike noise was found in an envelope pattern. Further, the average level of the S/N ratio was 20 dB to 22 dB, which was a preferable level.

As a result of evaluating a magnetic recording medium fabricated by providing a magnetic recording layer and the like on the soft magnetic under layer of one of the comparative examples shown in Table 2, the S/N ratio seriously decreased and magnetic symmetry with respect to the axis of the substrate could not be obtained.

As described above, the present invention provides a substrate suitable for fabricating a perpendicular magnetic recording medium having excellent signal reproduction characteristics with low noise, and a fabrication method thereof.

What is claimed is:

1. A substrate for a magnetic recording medium,
the substrate comprising a non-magnetic substrate shaped like a disk having a diameter of 90 mm or less and a soft magnetic under layer provided on a major surface of the substrate,
wherein the soft magnetic under layer is a plating layer mainly composed of at least two elements selected from the group consisting of Co, Ni, and Fe,
the plating layer has magnetic anisotropy provided by magnetic field heat treatment after film formation, the magnetic anisotropy is obtained with a difference (δH=H_{d}−H_{c}) of 5 oersteds (Oe) or more in terms of absolute value between a magnetization saturation magnetic field strength (H_{d}) in an in-plane radial direction and a magnetization saturation magnetic field strength (H_{c}) in an in-plane circumferential direction, and the magnetic anisotropy is symmetric with respect to an axis of the substrate.

2. A magnetic recording medium comprising a magnetic recording layer on the soft magnetic under layer of the substrate for a magnetic recording medium according claim 1.

3. The substrate for a magnetic recording medium according to claim 1, wherein the non-magnetic substrate is a silicon wafer and a base plating layer made of Ni or NiP is provided between the major surface of the substrate and the plating layer.

4. A magnetic recording medium comprising a magnetic recording layer on the soft magnetic under layer of the substrate for a magnetic recording medium according claim 3.

5. The substrate for a magnetic recording medium according to claim 1, wherein the plating layer contains at least one element selected from the group consisting of B, C, P and S.

6. A magnetic recording medium comprising a magnetic recording layer on the soft magnetic under layer of the substrate for a magnetic recording medium according claim 5.

7. The substrate for a magnetic recording medium according to claim 5, wherein the non-magnetic substrate is a silicon wafer and a base plating layer made of Ni or NiP is provided between the major surface of the substrate and the plating layer.

8. A magnetic recording medium comprising a magnetic recording layer on the soft magnetic under layer of the substrate for a magnetic recording medium according claim 7.

9. A method of fabricating a substrate for a magnetic recording medium,
the method comprising:
an electroless plating step of forming a soft magnetic film on a major surface of a non-magnetic substrate shaped like a disk having a diameter of 90 mm or less, and a step of performing magnetic field heat treatment on the soft magnetic film formed by the electroless plating step,
wherein in the electroless plating step, the soft magnetic film is formed by plating in which the substrate is dipped into a plating solution containing at least two metal ions selected from the group consisting of Co, Ni, and Fe, and
the magnetic field heat treatment step is performed such that magnetic anisotropy is obtained with a difference (δH=H_{d}−H_{c}) of 5 oersteds (Oe) or more in terms of absolute value between a magnetization saturation magnetic field strength (H_{d}) in an in-plane radial direction of the soft magnetic film and a magnetization saturation magnetic field strength (H_{c}) in an in-plane circumferential direction of the soft magnetic film and the magnetic anisotropy is symmetric with respect to an axis of the substrate.

10. The method of fabricating a substrate for a magnetic recording medium according to claim 9, wherein a silicon wafer is selected as the substrate, and
the method further comprises, before the electroless plating step, a step of forming a base plating layer made of Ni or NiP by dipping the silicon wafer into a plating bath containing a Ni ion or a plating bath obtained by adding a phosphorus reducing agent to a bath containing a Ni ion.

11. The method of fabricating the substrate for a magnetic recording medium according to claim 10, further comprising, before the step of forming the base plating layer, a substrate surface treatment step of removing an oxide film on a surface of the silicon wafer.

12. The method of fabricating a substrate for a magnetic recording medium according to claim 9, wherein magnetic field application means is used in the magnetic field heat treatment, the magnetic field application means being capable of obtaining a magnetic field application area on a surface of the soft magnetic film as large as or larger than one twentieth of an area of the soft magnetic film, and a magnetic field is applied while at least one of the non-magnetic substrate and the magnetic field application means is rotated about the axis of the substrate.

13. The method of fabricating the substrate for a magnetic recording medium according to claim 12, wherein a silicon wafer is selected as the substrate, and
the method further comprises, before the electroless plating step, a step of forming a base plating layer made of Ni or NiP by dipping the silicon wafer into a plating bath containing a Ni ion or a plating bath obtained by adding a phosphorus reducing agent to a bath containing a Ni ion.

14. The method of fabricating the substrate for a magnetic recording medium according to claim 13, further comprising, before the step of forming the base plating layer, a substrate surface treatment step of removing an oxide film on a surface of the silicon wafer.

15. The method of fabricating a substrate for a magnetic recording medium according to claim 9, wherein in the magnetic field heat treatment, a heat treatment temperature is 150° C. to 350° C., a magnetic field applied to the substrate has a strength of 50 oersteds (Oe) or more, and a treatment time is selected within a range of five minutes to ten hours.

16. The method of fabricating the substrate for a magnetic recording medium according to claim 15, wherein a silicon wafer is selected as the substrate, and
the method further comprises, before the electroless plating step, a step of forming a base plating layer made of Ni or NiP by dipping the silicon wafer into a plating bath containing a Ni ion or a plating bath obtained by adding a phosphorus reducing agent to a bath containing a Ni ion.

17. The method of fabricating the substrate for a magnetic recording medium according to claim 16, further comprising, before the step of forming the base plating layer, a substrate surface treatment step of removing an oxide film on a surface of the silicon wafer.

18. The method of fabricating the substrate for a magnetic recording medium according to claim 15, wherein magnetic field application means is used in the magnetic field heat treatment, the magnetic field application means being capable of obtaining a magnetic field application area on a surface of the soft magnetic film as large as or larger than one twentieth of an area of the soft magnetic film, and a magnetic field is applied while at least one of the non-magnetic substrate and the magnetic field application means is rotated about the axis of the substrate.

19. The method of fabricating the substrate for a magnetic recording medium according to claim 18, wherein a silicon wafer is selected as the substrate, and
the method further comprises, before the electroless plating step, a step of forming a base plating layer made of Ni or NiP by dipping the silicon wafer into a plating bath containing a Ni ion or a plating bath obtained by adding a phosphorus reducing agent to a bath containing a Ni ion.

20. The method of fabricating the substrate for a magnetic recording medium according to claim 19, further comprising, before the step of forming the base plating layer, a substrate surface treatment step of removing an oxide film on a surface of the silicon wafer.
